(19) United States
(12) Patent Application Publication
(10) Pub. No.: US 2016/0246565 A1
(43) Pub. Date: Aug. 25, 2016

(54) SONG BEAT/EXERCISE TEMPO SYNCHRONIZATION APPARATUS

(71) Applicants: Philip J. Shaheen, Oak Park, MI (US); James S. Potter, Chicago, IL (US)

(72) Inventors: Philip J. Shaheen, Oak Park, MI (US); James S. Potter, Chicago, IL (US)

(21) Appl. No.: 15/052,182

(22) Filed: Feb. 24, 2016

Related U.S. Application Data
(60) Provisional application No. 62/119,867, filed on Feb. 24, 2015.

(51) Int. Cl. G06F 3/16; H04R 1/10

(52) U.S. Cl. CPC G06F 3/165; H04R 1/1041; G10H 2210/381; G10H 2210/385; G10H 2220/395

(57) ABSTRACT

An apparatus for synchronizing an audio stream beat with a movement tempo enclosed audio device generating an audio stream. The detectors determine the beat per unit time of the audio stream and the tempo of movement of a user. Control input carried on a user's finger control the play of the audio device and the synchronization operation. In one aspect, the audio device and the control input are carried in a sleeve worn on a user's finger and wirelessly transmit the synchronized audio stream to headphones worn by a user. In another aspect, the audio device and an accelerometer for detecting user tempo are mounted in the headphone and wirelessly receive control input from the finger mounted control input.

### CROSS REFERENCE TO RELATED APPLICATION

This application claims priority to benefit to U.S. Provisional Patent Application Ser. No. 62/119,867, filed Feb. 24, 2015.

### BACKGROUND

The present apparatus relates, in general, to devices for synchronizing the beat of an audio stream or song with an external exercise tempo or rhythm of a user.

### SUMMARY

An audio beat/user tempo synchronization apparatus includes an audio player generating an audio stream. User inputs are carried on a mount that is adapted to be mounted on a user's finger. An accelerometer determines the user's tempo in beats per unit time of movement of the user. A control is coupled to the audio player and detects the beats per unit time of the audio stream. The control synchs the beats per unit time of the audio stream to the beats per unit time of the user's tempo in response to signals from the user input.

The mount may be a hollow sleeve mountable over a user's finger, the sleeve carrying the user inputs.

The user input may include at least one removable button carried by the sleeve for generating input signals to control at least one of the audio player and the synch frequency of the audio stream. The at least one button may include a first button carried by the mount for operating the audio device, and at least one second button carried by the mount for implementing synchronization of the beats per unit time of the audio stream 60 beats per unit time of the user's tempo.

Any or both of the first and second button may be in the form of multi-function buttons containing a plurality of independently depressible portion.

The control transmits the synched beats per unit time of the audio stream to the audio broadcast device. The audio broadcast device includes at least one speaker, such as the speaker headphones adapted to be worn on a user's head.

In one aspect, the accelerometer, the control and the audio player are mounted in the sleeve adapted to be worn on the user's finger. A wireless transmitter is carried by the sleeve and coupled to the control for wirelessly transmitting the synched beats per unit time of the audio stream to a remotely located audio broadcast device. In this aspect, the remote audio broadcast device is headphones carrying an audio output speaker and a wireless receiver.

In another aspect, the user inputs are coupled to a wireless transmitter carried in the sleeve for wirelessly transmitting the user input signal to the control remotely located from the sleeve. In this aspect, the control, the accelerometer and the audio player may be carried in headphone along with the audio speaker in a wireless receiver.

In another aspect, the audio beat/user tempo synchronization apparatus includes an audio player generating an audio stream. User inputs are carried in a mount adapted to be mounted on a user's finger. An accelerometer determines the user's tempo and beats per unit time of movement of the user. A control is coupled to the audio player detects the beats per unit time of the audio stream. The pairs that control synch the beats per unit time of the audio stream to the beats per unit time of the user's tempo in response to the user input. An audio output device, which may be in the form of an audio speaker, is carried on headphones adapted to be worn by the user.

The accelerometer, the control, and the audio player in this aspect are carried by the headphones. A wireless transmitter is coupled to the user input for wirelessly transmitting user input signals. A wireless receiver is carried by the headphones and coupled to the control for receiving the user input.

The above describes a synchronization apparatus that automatically detects the beats per unit time of audio stream in the tempo of a user's movement, such as running, walking, etc. The control operates as a tempo modulator to find the difference between the original tempo of the song and the pace tempo set by the user's movement. This change in audio playback frequency is accomplished without any change in pitch of the broadcast audio stream.

### BRIEF DESCRIPTION OF THE DRAWING

The various features, advantages and other uses of the present song beat/exercise tempo synchronization apparatus can be had by referring to the following detailed description and drawing.

FIG. 1 is a perspective view showing the song beat/exercise tempo synchronization apparatus worn on user's fingers.

FIG. 2 is a pictorial representation of the circuit boards underlying the push buttons shown in FIG. 1.

FIG. 3 is an enlarged plan view of the apparatus without the attachment sleeve.

FIG. 4 is a pictorial representation showing an aspect of the apparatus in use.

FIG. 5 is a pictorial representation of the recharging state of the apparatus depicted in a coupled arrangement with headphones.

FIG. 6 is a schematic diagram of the apparatus circuitry.

FIG. 7 is a graph depicting the acceleration wave forms detected by the accelerometer shown in FIG. 6.

FIG. 8 is a graphic representation of an audio stream generated by the apparatus.

FIG. 9 is a graphic representation of the audio stream shown in FIG. 8 changed to a different tempo by the apparatus.

FIG. 10 is a flow chart depicting a sequence of operation of the apparatus.

FIG. 11 is an enlarged elevational view of the attachment sleeve, similar to the attachment sleeve shown in FIG. 3.

FIG. 12 is a perspective view of headphones incorporating MP3 player and accelerometer in another aspect of the apparatus.

FIG. 13A is a schematic block diagram of the headphone music player aspect shown in FIG. 12.

FIG. 13B is a schematic block diagram of the finger sleeve remote control shown in FIG. 11.

### DETAILED DESCRIPTION

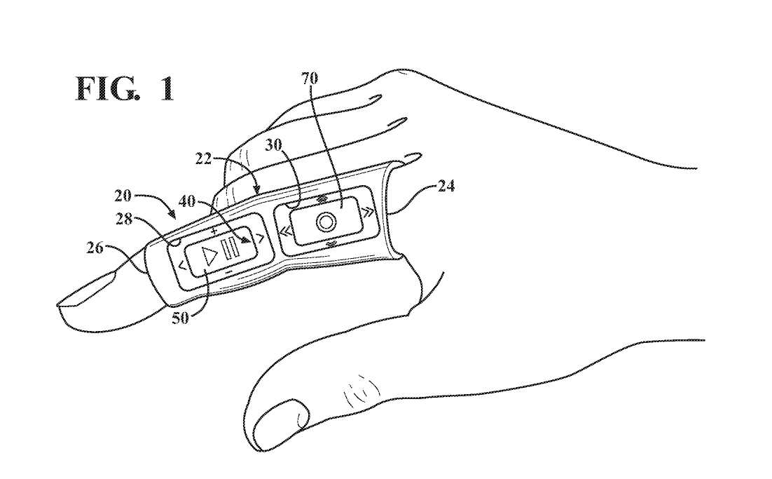

FIGS. 1-6 depict an apparatus 20 for synchronizing the beat of an audio stream or song with an exercise tempo based on the tempo of a user's arm swings.

The apparatus 20 includes a user attachment in the form of the cylindrical finger sleeve 22 which can be formed of flexible material. The finger sleeve 22 has opposed open ends 24 and 26 to enable it be easily pulled over or removed from a user's finger while still being snuggly retained on the finger.

Alternately, the finger sleeve 22 may be formed of a strapped body with opposed edge fasteners, such as mating Velcro strips, etc.

The finger sleeve 22 includes two apertures or windows 28 and 30, which expose the operable buttons of the beat/tempo synchronization device 40. The buttons do not necessarily need to be exposed by openings in the sleeve. The buttons may be covered by labeled parts of the sleeve, with the buttons raised up and felt by the user through the sleeve.

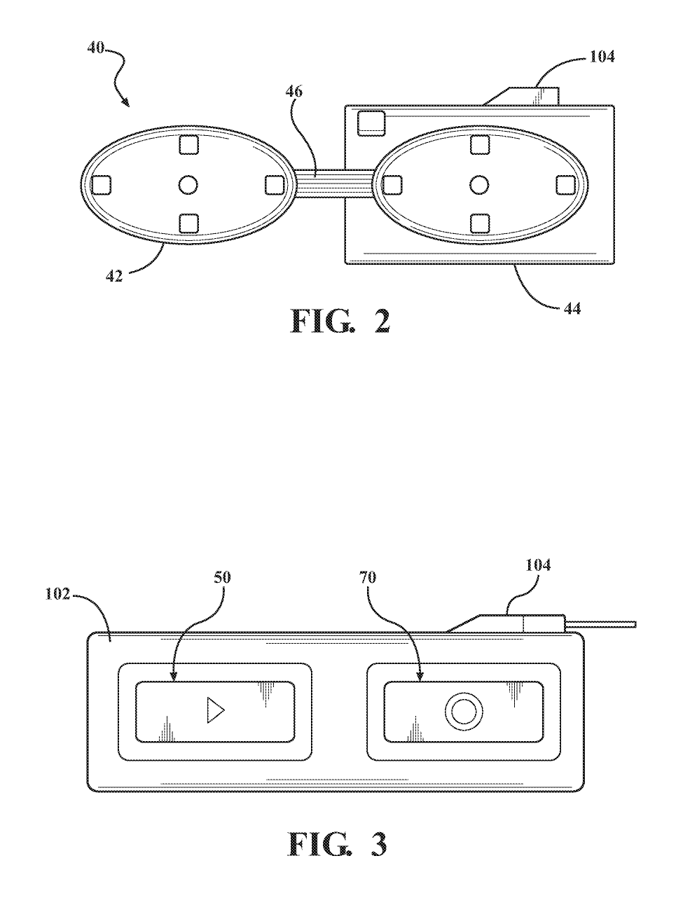

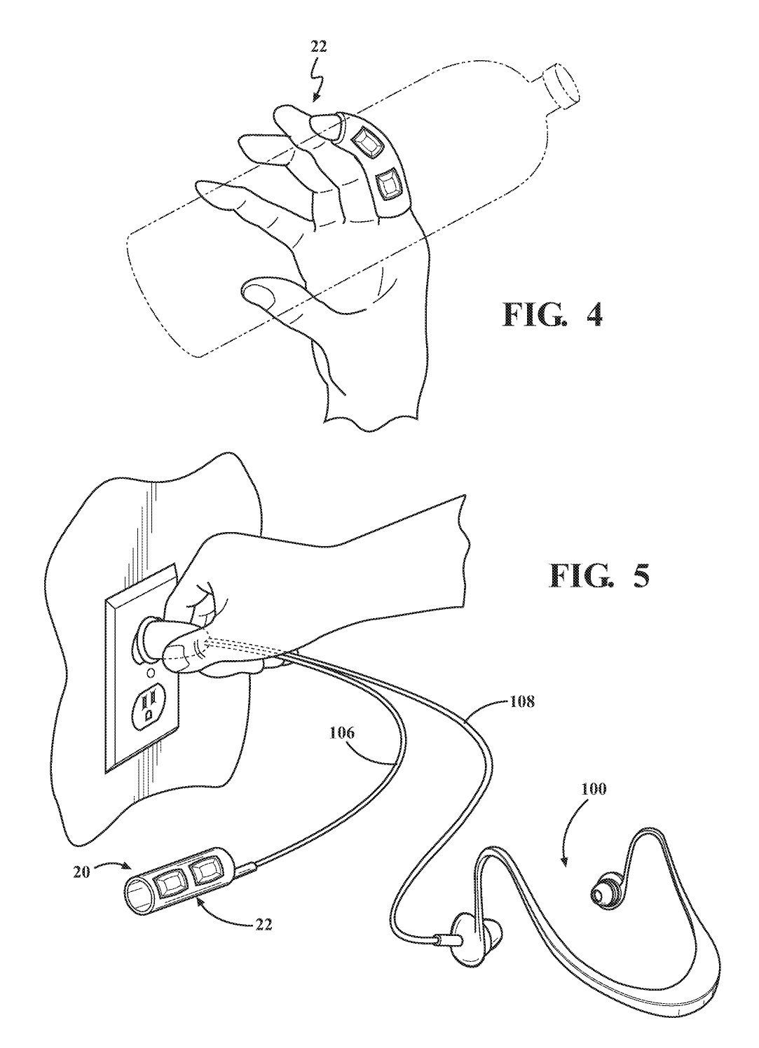

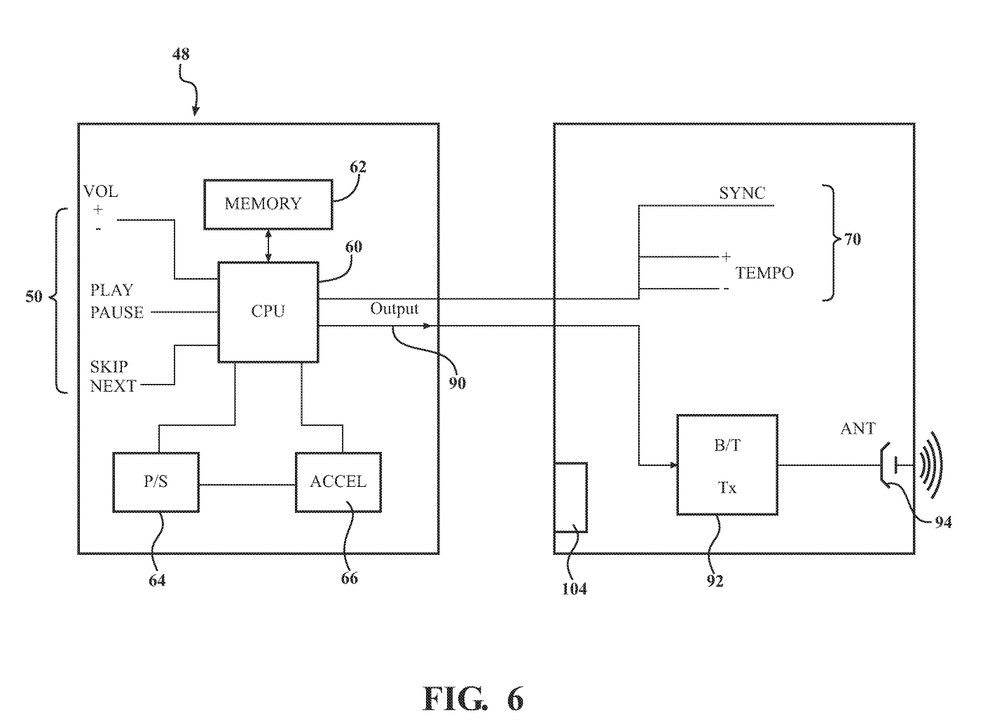

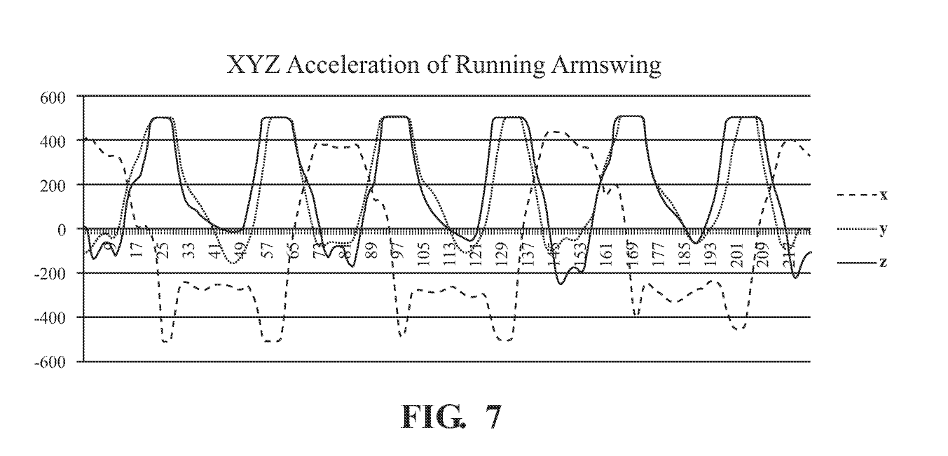

One aspect of the device 40 is shown in FIG. 2, where two circuit boards 42 and 44 are flexibly connected by conductors or a cable 46. This allows the user to bend his or her finger as part of an exercise or to grasp a bottle or drink container as shown in FIG. 4. The circuit board 42 is part of an audio player, such as a MP3 player 48, FIG. 6, which may contain a processor, memory and circuitry to play audio streams or songs stored in a memory at user request.

The MP3 player 48 mounted on the circuit board 42 includes one or more buttons with one large multifunction button 50 as shown in FIGS. 1 and 2. The button 50 is depressible along multiple edges as well as at a depressible center portion to effect different functions. The left and right edges of the button 50 may be separately depressed to implement previous songs and next song selections. Plus and minus symbols adjacent the top and bottom edges of the button 50 provide a volume increase and volume decrease controls. The center portion of the button 50 is devised for consecutive depression to implement play/pause functions of the MP3 player 48.

As shown in FIG. 6, the MP3 player 48 includes a processor or CPU 60 which accesses audio streams stored in a memory 62. The button 50 controls are connected as inputs to the processor 60. An onboard power supply 64, which may be a rechargeable battery, supplies power to the operable elements of the MP3 player 48.

An accelerometer 66 is also mounted on the circuit board 42 or may be part of the MP3 player 48 mounted on the circuit board 42. The accelerometer 66 provides three dimensional x, y and z axis output signals representative of the direction of movement of the MP3 player 48, and indirectly, the rhythm or tempo of movement of the users' arms, when the MP3 player 48 mounted on a finger of the user.

The circuit board 44 may support a second button 70. The button 70 may also be a multifunction button providing, for example, at least three functions. Depression of the center of the button 70 implements the sync beat/tempo function as described hereafter. Consecutive depression of the button may return operation to normal play speed. Either the top and bottom edges or the left and right edges of the button 70 may be depressed to provide a manual tempo change to increase the song beat or to decrease the song beat.

As shown in FIG. 6, the audio output 90 of the MP3 player 48 may be input to circuitry mounted on the circuit board 44. Such circuitry can include the output terminal connections of the multifunction button 70 which are connected as inputs to the processor 60 of the MP3 player 48. The audio output 90 of the MP3 player 48 is connected to a wireless transmitter, such as a Bluetooth transmitter 92 mounted on the circuit board 44. The transmitter 92 is coupled through an antenna 94 to generate a wireless audio stream which is received by a complementary Bluetooth receiver in an audio broadcast device, such as wireless headphones 100 as shown, for example, in FIG. 5.

An alternate arrangement of the apparatus 20 is shown in FIG. 3 wherein both of the multifunction buttons 50 and 70 are mounted on a single rigid or flexible circuit board 102. The single circuit board 102 shown in FIG. 3 and the circuit board 44 shown in the aspect of the apparatus 30 shown in FIG. 2 may include a jack 104 which provides connectivity to an external recharge cord 106 shown in FIG. 5 or to wired headphones if the user wishes not to use wireless headphones. A separate cord 108 may also be provided to recharge the wireless headphone 100.

In operation, the MP3 player 48 is activated and generates an audio stream or song to the wireless headphones 100. The accelerometer 66 will detect the user's tempo or exercise pace, including running or walking pace, by arm swing. The accelerometer 66, whose input is provided to the processor 60, generates x, y, and z acceleration waveforms, shown in FIG. 7.

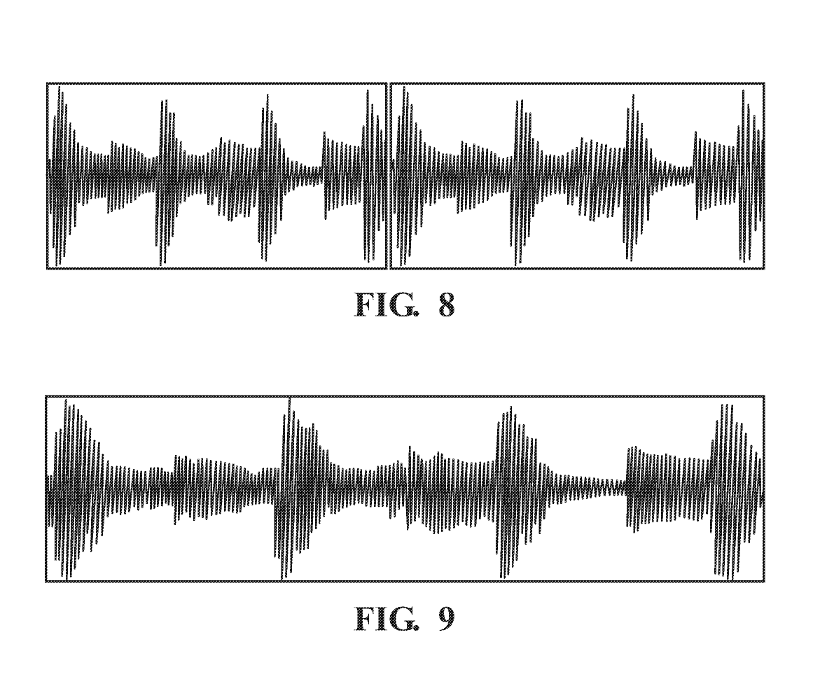

The processor 60 of the MP3 player, executing a control program, determines the beats per unit time, for example, in beats per minutes (BPM) of each song or audio stream as shown in FIG. 8.

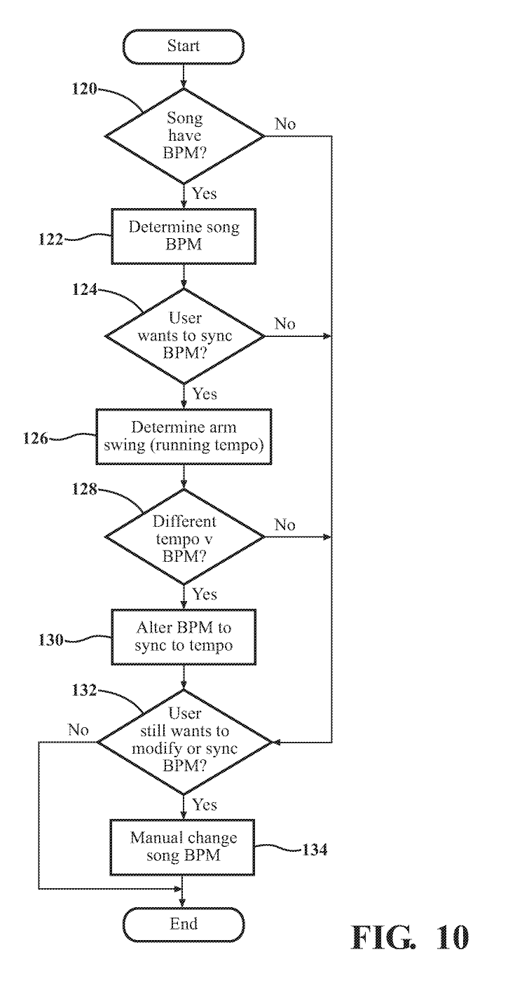

The processor or CPU 60, again executing the control program, can change the BPM of the song or audio stream played by the MP3 player 48, as shown in FIG. 8, to a different tempo or BPM, without changing the pitch of the audio stream as shown in FIG. 9. This essentially syncs or matches the BPM of the audio stream generated by the MP3 player 48 with the exercise or movement tempo or beat of the user as determined by the CPU 60 based on the acceleration waveforms.

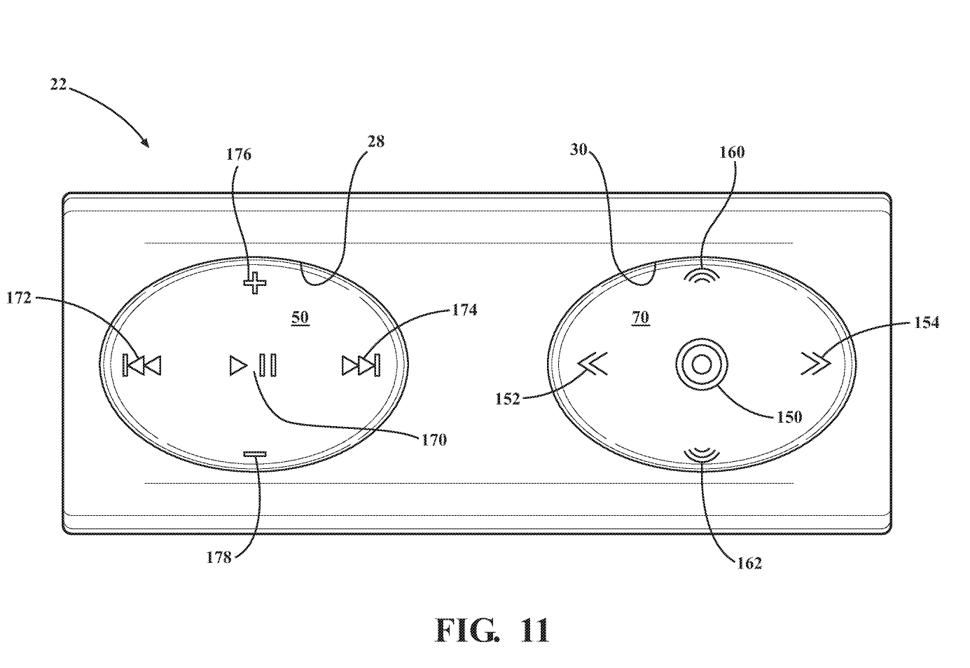

As shown in FIG. 10, the CPU 60 executes the control program as follows.

In step 120, the CPU 60 determines whether or not the audio stream currently being generated by the MP3 player 48 has a beat per minute (BPM). If yes, the CPU 60, in step 122, determines BPM of the song, as shown in the waveform of FIG. 8.

In step 124, the user depresses the sync button 70 on the user's finger. The button 70 can be programmed to detect a depression only if the button is depressed for a certain length of time, such as five seconds, in order to prevent inadvertent operation of the apparatus 20.

After the user has depressed the button 70 in step 124 to indicate that the user wants to sync the song BPM to the user's movement tempo, the CPU 60, using the output of the accelerometer 66, determines the user's movement tempo via arm swing or running tempo in step 126.

The CPU 60 in step 128 then determines if there is a difference between user's movement tempo and the song BPM. If there is a difference, the CPU 60, in step 130, executing the control program, which may utilize a Fourier Transform, changes the frequency of the song BPM to sync with the tempo or BPM of the user's movements. Such frequency BPM modification is done without changing the pitch of the audio stream. For example, the CPU 60 may initially change the BPM of the song to match or sync with the tempo of the user, and then reverse the pitch of the altered audio stream back to the original pitch of the audio stream or song.

For example, take a user who swings their arms 60 times per minute during an exercise, such as running, walking, etc. Synchronization of the song BPM to the user's tempo can be 1:1 or the nearest whole multiple of the user's tempo, such as 2× or 3×. Thus, for a person who swings their arms 60 times per minute during an exercise movement, the CPU 60 can sync a 127 BPM song to 120 BPM, a 174 BPM song to 180 BPM, and a 70 BPM song to 60 BPM.

Referring again to FIG. 10, if the song does not have a BPM as determined in step 120, or if the user does not want to sync the BPM in step 124 or if the user still wants to modify or sync the song BPM to the user's tempo after the CPU 60 has synced the BPM to the user's tempo, the user, in step 132, can depress the manual tempo increase or tempo decrease portions of the multifunction button 70 to increase or decrease the song BPM to suit the user's likes in step 134.

If the user ever wishes to return to natural or normal play speed of a song, the user may press the button 70 once and, if the song is not at its natural recorded speed, it will return to its recorded speed.

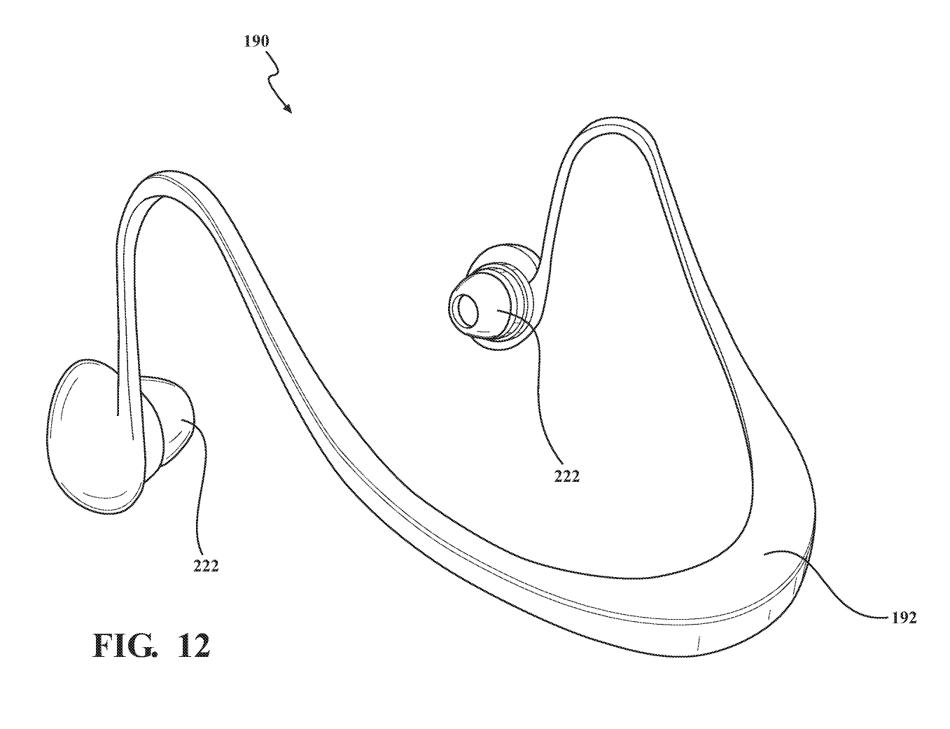

Refer now to FIGS. 11-13B, there is depicted another aspect of the present apparatus. FIG. 11 depicts the finger sleeve 22 which is essentially the same as the finger sleeve 22 shown in FIGS. 1-3. The finger sleeve 22 supports two multi-function push buttons 50 and 70, which can be depressible in multiple locations to provide different function output from each button 50 and 70 to a Bluetooth transmitter. For example, button 50 includes a center depressible area 150 which can be depressed or pushed to down state to sync the song speed to the tempo beat of the user. The center portion 150 of the button 70 can also be quickly tapped to return to the normal song beat. Opposed depressible portions 152 and 154 respectively provide skipping to the next fullest sync speed, for example, from 1× to 0.5× for the depressible portion 152 or skipping to the next fastest sync speed, for example, from 1× to 2× when the depressible portion 154 is depressed. The immediate depressible portions 160 and 162 respectively allow the user to speed up the song beat by depressing portion 160 or to slow the song beat down by depressing portion 162.

The multi-function button 50 likewise has a plurality of separately and independently depressible portions including an elevated central portion 170 which provides play and the pause of the audio device or MP3 player with alternate taps. Opposed depressible portions 172 and 174 respectively allow the user to select the previous song by depressing portion 172 or advancing to the next song by depressing portion 174. Depressible portions 176 and 178 respectively allow the user to turn the audio volume up or down.

It will be understood that each of the buttons 50 and 70 may be provided with an individual Bluetooth transmitter and power supply. Alternately, the above described functions of the buttons 50 and 70 or additional functions may be provided by combining the button 50 and 70 into a single button with multiple depressible portions, such as five depressible portions, for example, and providing the processor coupled to the single button with the capability to recognize single or double taps or depressions of each depressible portion to implement different functions. For example, in the single button, all of the functions of button 50 can be activated by a single tap of each different portion. The functions of button 70 can be accessed by double taps of the depressible portions of the single button.

The button functionality can be 10 functions, for example: 1) Play/Pause, 2) Song skip forward, 3) song skip backwards, 4) Volume increase, 5) Volume decrease, 6) Synch play speed to accelerometer rate, 7) Play speed increase, 8) Play speed decrease, 9) Return to normal play speed, and 10) Bluetooth synch. The first five would be for one button face or the single tap functions and 6-10 would be for the other button face or the press and hold or double tap functions.

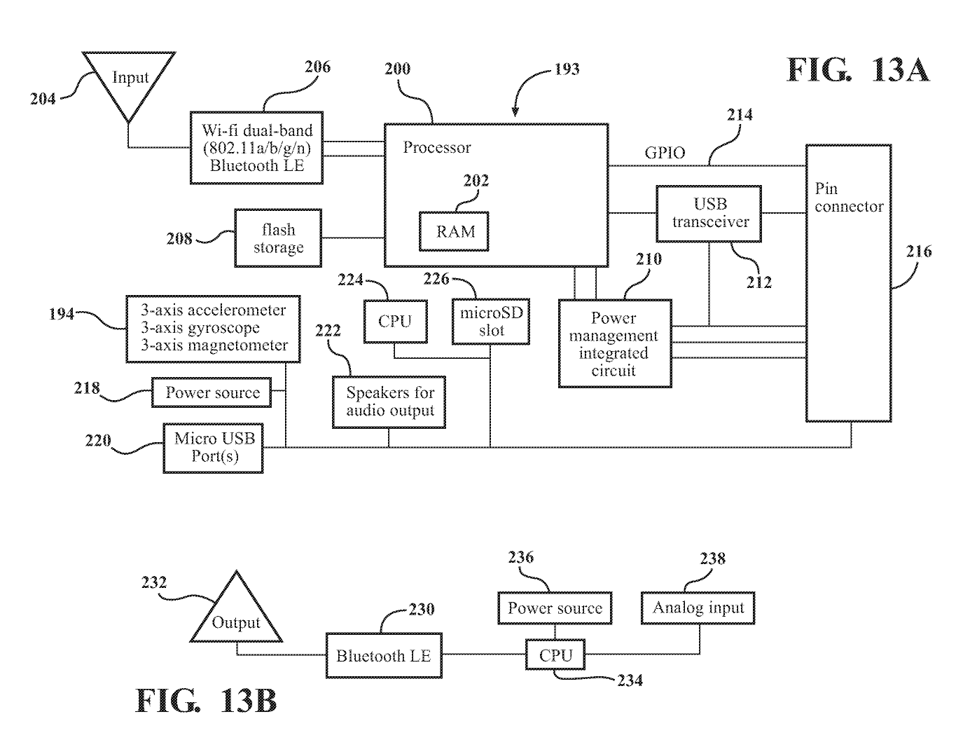

In this aspect, an MP3 player 193 and an accelerometer 194 are mounted in headphones 190 worn about the head of the user. For example, the MP3 player 193 and the accelerometer 194, as well as the additional circuit elements shown in FIG. 13A can be mounted in the enlarged rear portion 192 of the headphone 190.

In this aspect, the mounting of the accelerometer 194, FIG. 13A, in the headphone 190 captures the tempo of the user by detecting movement of the user of during each step taken by the user.

Operative control elements mounted in the headphone 190 include an MP3 processor 200 with internal memory, such as RAM 202, which stores the music or other audio media. An input antenna 204 captures the Bluetooth signal from the finger sleeve 22. The antenna 204 is coupled to a Bluetooth receiver 206 which is connected as an input to the processor 200. The processor 200 syncs the beat per unit time of the audio stream to the beat per unit time of the user's tempo as described above.

Additional memory 208, such as a memory in the form of a flash memory, can also be coupled to the processor 200 for additional audio media storage. Outputs from the processor 200 are coupled to a power management integrated circuit 210, a USB transceiver 212, and an audio output 214, all of which are coupled to a pin connector 216. The pin connector 216 is in turn connected to the three axis accelerometer 194, an internal power source 218 for all of the operative elements contained in the headphones 190, a micro USB port 220, headphone speakers 222 for audio output, data management CPU 224, and a micro USB port(s) 226, receiving the micro USB card which may contain audio media.

Control inputs to the MP3 player processor 200 are transmitted from the finger sleeve 22 by a Bluetooth transceiver 230 through an antenna 232. A CPU 234 is coupled to and controls the Bluetooth transceiver 230. An internal power source 236 is mounted in the finger sleeve 22 and coupled to the CPU 234 for powering the circuit element powered in the finger sleeve 22. Analog control signals 238 are input to the CPU 234. Such audio input signals include signals generated by any of the depressible portions of the push buttons 50 and 70 or the above described optional single push button.

What is claimed is:

1. An audio beat/user tempo synchronization apparatus, comprising:
an audio player generating an audio stream;
user inputs, carried on a mount, adapted to be mounted on a user's finger;
an accelerometer detector determining a user's tempo in beats per unit time of movement of the user;
a control coupled to the audio player and detecting the beats per unit time of the audio stream; and
the control synchs the beats per unit time of the audio stream to the beats per unit time of the user's tempo.

2. The apparatus of claim 1, wherein the mount comprises:
a sleeve adapted for removable attachment to a user's finger.

3. The apparatus of claim 1, wherein the user inputs comprise:
at least one button carried by the mount for generating input signals to control at least one of the audio player and the synch frequency of the audio stream.

4. The apparatus of claim 1, wherein the user inputs further comprise:
a first button carried by the mount for operating the audio device generating the audio stream; and
at least one second button carried by the mount for implementing synchronization of the beats per unit time of the audio stream to the beats per unit time of the user's tempo.

5. The apparatus of claim 4, further comprising:
the at least one second button providing manual changes of the synced beats per unit time of the audio stream.

6. The apparatus of claim 1, further comprising:
the control transmitting the synced beats per unit time of the audio stream to a audio broadcast device.

7. The apparatus of claim 6, wherein:
The audio broadcast device is at least one speaker carried in headphones. The apparatus of claim 7, further comprising:
the accelerometer, the user inputs the audio player and the control are carried in the mount, the control wirelessly coupled to the audio broadcast device and to the audio device in the remote audio player.

9. The apparatus of claim 8, wherein:
the audio player is an MP3 player coupled to audio output speakers carried in headphones removably mountable on a user's head.

10. The apparatus of claim 8, further comprising:
the Bluetooth transmitter coupled to the control to transmitting the synch audio stream to a Bluetooth transmitter coupled to the audio broadcast device.

11. The apparatus of claim 6, wherein:
the audio player and the accelerator mountable on a user and coupled to the audio broadcast device.

12. The apparatus of claim 11, further comprising:
a wireless Bluetooth transmitter coupled to the user input for transmitting user input signal to a Bluetooth receiver coupled to the control.

13. The apparatus of claim 12, further comprising:
headphones removably mountable on a user head and carrying the audio broadcast device in the form of audio output speakers;
the audio player, the accelerator and the Bluetooth receiver mountable in the headphones.

14. An audio beat/user tempo synchronization apparatus, comprising:
an audio player generating an audio stream;
user input, carried on a mount, adapted to be mounted on a user's finger;
a wireless transmitter coupled to the user input for wirelessly transmitting user input signal;
a control coupled to a wireless receiver for receiving the user input signal;
an accelerometer determining a user's tempo in beats per unit time of movement of the user;
the accelerometer, the control and the audio player carried by headphones removably mountable on a user's head, the headphones carrying an audio broadcast device in the form of one audio output speaker;
the control synchs the beats per unit time of the audio stream to the beats per unit time of the user's tempo.

15. The apparatus of claim 13, wherein the mount comprises:
a sleeve adapted for removable attachment to a user's finger.

16. The apparatus of claim 13, wherein the user input comprises:
at least one button carried by the mount for generating input signals to control at least one of the audio player and the synch frequency of the audio stream.

17. The apparatus of claim 13, wherein the user input further comprises:
a first button carried by the mount for operating the audio device generating the audio stream; and
at least one second button carried by the mount for implementing synchronization of the beats per unit time of the audio stream to the beats per unit time of the user's tempo.

18. The apparatus of claim 16, further comprising:
the at least one second button providing manual changes of the synced beats per unit time of the audio stream.
